(19) United States
(12) Patent Application Publication
(10) Pub. No.: US 2024/0340905 A1
(43) Pub. Date: Oct. 10, 2024

(54) METHOD AND DEVICE FOR DELAY INFORMATION REPORTING

(71) Applicant: FG Innovation Company Limited, Tuen Mun (HK)

(72) Inventors: Chia-Hung Wei, Taipei (TW); Tzu-Wen Chang, Taipei (TW)

(21) Appl. No.: 18/628,797

(22) Filed: Apr. 7, 2024

Related U.S. Application Data
(60) Provisional application No. 63/457,806, filed on Apr. 7, 2023.

(51) Int. Cl. H04W 72/21; H04W 24/10; H04W 72/231

(52) U.S. Cl. CPC H04W 72/21; H04W 24/10; H04W 72/231

(57) ABSTRACT

A method for delay information reporting is provided. The method receives a threshold via RRC signaling. The method determines whether at least one of delay budgets of one or more packets buffered in a first logical channel group LCG is below the threshold. In a case that at least one delay budget is below the threshold, the method triggers a delay information reporting (DR); determines whether at least one uplink resource is available for a MAC CE for the DR; and in a case that the at least one UL resource is available, generates the MAC CE by including delay information associated with a first delay range for the first LCG, and transmits the MAC CE on the at least one UL resource.

### CROSS-REFERENCE TO RELATED APPLICATION(S)

The present disclosure claims the benefit of and priority to U.S. Provisional Patent Application Ser. No. 63/457,806, filed on Apr. 7, 2023, entitled “ENHANCED BSR PROCEDURE IN NR,” the content of which is hereby incorporated herein fully by reference into the present disclosure for all purposes.

### FIELD

The present disclosure generally relates to wireless communications and, more particularly, to methods and devices for delay information reporting.

### BACKGROUND

Various efforts have been made to improve different aspects of wireless communication for cellular wireless communication systems, such as the 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to grow, however, there is a need for further improvements in wireless communication in the next-generation wireless communication systems.

### SUMMARY

The present disclosure is directed to methods and devices for delay information reporting.

According to a first aspect of the present disclosure, a method performed by a User Equipment (UE) is provided. The method includes receiving a first threshold via radio resource control (RRC) signaling; determining whether at least one of one or more delay budgets of one or more packets buffered in a first logical channel group LCG is below the first threshold. In a case that the at least one of the one or more delay budgets of the one or more packets buffered in the first LCG is below the first threshold, the method further includes triggering a first delay information reporting (DR); determining whether at least one uplink resource is available for a medium access control (MAC) control element (CE) for the first DR; and in a case that the at least one UL resource is available for the MAC CE for the first DR, generating the MAC CE by including delay information associated with a first delay range for the first LCG, and transmitting the MAC CE based on the at least one UL resource.

In some implementations of the first aspect of the present disclosure, the delay information associated with the first delay range for the first LCG indicates a smallest delay budget within the first LCG.

In some implementations of the first aspect of the present disclosure, the MAC CE includes information associated with a number of LCGs corresponding to the delay information.

In some implementations of the first aspect of the present disclosure, the method further includes determining buffer information indicating an amount of data for transmission in the first LCG based on the amount of data and a first mapping table; and including the buffer information in the MAC CE.

In some implementations of the first aspect of the present disclosure, the method further includes: selecting the first mapping table from a plurality of pre-defined mapping tables.

In some implementations of the first aspect of the present disclosure, the method further includes: receiving a second threshold via the RRC signaling; determining whether at least one of one or more delay budgets of one or more packets buffered in a second LCG is below the second threshold. In a case that the at least one of the one or more delay budgets of the one or more packets buffered in the second LCG is below the second threshold, the method further includes: triggering a second DR, determining whether the at least one uplink resource is available for the MAC CE for the first DR including determining whether the at least one uplink resource is available for the MAC CE for the first DR and the second DR, and in a case that the at least one UL resource is available for the MAC CE for the first DR and the second DR, the MAC CE is generated by further including the delay information associated with a second delay range for the second LCG.

In some implementations of the first aspect of the present disclosure, the delay information associated with the second delay range for the second LCG indicates a smallest delay budget within the second LCG.

According to a second aspect of the present disclosure, a UE is provided. The UE includes at least one processor and at least one non-transitory computer-readable medium coupled to the at least one processor and storing one or more computer-executable instructions. The at least one processor configured to execute the one or more computer-executable instructions to cause the UE to: receive a first threshold via RRC signaling; determine whether at least one of one or more delay budgets of one or more packets buffered in a first LCG is below the first threshold. In a case that the at least one of the one or more delay budgets of the one or more packets buffered in the first LCG is below the first threshold, the at least one processor is configured to execute the one or more computer-executable instructions to further cause the UE to: trigger a first DR; determine whether at least one uplink resource is available for a MAC CE for the first DR; and in a case that the at least one UL resource is available for the MAC CE for the first DR, generate the MAC CE by including delay information associated with a first delay range for the first LCG, and transmit the MAC CE based on the at least one UL resource.

In some implementations of the second aspect of the present disclosure, the delay information associated with the first delay range for the first LCG indicates a smallest delay budget within the first LCG.

In some implementations of the second aspect of the present disclosure, the MAC CE includes information associated with a number of LCGs corresponding to the delay information.

In some implementations of the second aspect of the present disclosure, the at least one processor is configured to execute the one or more computer-executable instructions to further cause the UE to: determine buffer information indicating an amount of data for transmission in the first LCG based on the amount of data and a first mapping table; and include the buffer information in the MAC CE.

In some implementations of the second aspect of the present disclosure, the at least one processor is configured to execute the one or more computer-executable instructions to further cause the UE to: select the first mapping table from a plurality of pre-defined mapping tables.

In some implementations of the second aspect of the present disclosure, the at least one processor is configured to execute the one or more computer-executable instructions to further cause the UE to: receive a second threshold via the RRC signaling; determine whether at least one of one or more delay budgets of one or more packets buffered in a second LCG is below the second threshold. In a case that the at least one of the one or more delay budgets of the one or more packets buffered in the second LCG is below the second threshold, the at least one processor is configured to execute the one or more computer-executable instructions to further cause the UE to: trigger a second DR, determining whether the at least one uplink resource is available for the MAC CE for the first DR including determining whether the at least one uplink resource is available for the MAC CE for the first DR and the second DR, and in a case that the at least one UL resource is available for the MAC CE for the first DR and the second DR, the MAC CE is generated by further including the delay information associated with a second delay range for the second LCG.

In some implementations of the second aspect of the present disclosure, the delay information associated with the second delay range for the second LCG indicates a smallest delay budget within the second LCG.

### BRIEF DESCRIPTION OF THE DRAWINGS

Aspects of the example disclosure are best understood from the following detailed description when read with the accompanying figures. Various features are not drawn to scale. Dimensions of various features may be arbitrarily increased or reduced for clarity of discussion.

FIG. 1 is a diagram illustrating a format of a Buffer Status Report (BSR) Medium Access Control (MAC) Control Element (CE), according to an example implementation of the present disclosure.

FIG. 2 is a diagram illustrating a format of a BSR MAC CE, according to an example implementation of the present disclosure.

FIG. 3 is a diagram illustrating a format of a delay information reporting (DR) MAC CE, according to an example implementation of the present disclosure.

FIG. 4 is a diagram illustrating another format of the DR MAC CE, according to an example implementation of the present disclosure.

FIG. 5 is a diagram illustrating another format of the DR MAC CE, according to an example implementation of the present disclosure.

FIG. 6 is a diagram illustrating another format of the DR MAC CE, according to an example implementation of the present disclosure.

FIG. 7 is a diagram illustrating another format of the DR MAC CE, according to an example implementation of the present disclosure.

FIG. 8 is a diagram illustrating another format of the DR MAC CE, according to an example implementation of the present disclosure.

FIG. 9 is a diagram illustrating another format of the DR MAC CE, according to an example implementation of the present disclosure.

FIG. 10 is a flowchart for a method/process for delay information reporting, according to an example implementation of the present disclosure.

FIG. 11 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrase “in some implementations,” which may refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C,” “at least one of the following: A, B and C,” “at least one of A, B or C,” and “at least one of the following: A, B or C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any NW function(s) or algorithm(s) described in the present disclosure may be implemented by hardware, software, or a combination of software and hardware. Described functions may correspond to modules which may be software, hardware, firmware, or any combination thereof. The software implementation may include computer executable instructions stored on computer readable medium, such as a memory or other types of storage devices. For example, one or more microprocessors or general-purpose computers with communication processing capability may be programmed with corresponding executable instructions and carry out the described NW function(s) or algorithm(s). The microprocessors or general-purpose computers may be formed of Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication NW architecture (e.g., a Long Term Evolution (LTE) system, an LTE-Advanced (LTE-A) system, an LTE-Advanced Pro system, or a 5G New Radio (NR) Radio Access Network (RAN)) typically includes at least one Base Station (BS), at least one User Equipment (UE), and one or more optional NW elements that provide connection toward the NW. The UE communicates with the NW (e.g., a Core Network (CN), an Evolved Packet Core (EPC) NW, an Evolved Universal Terrestrial Radio Access Network (E-UTRAN), a 5G Core (5GC), or an internet), through a RAN established by one or more BSs.

It should be noted that, in the present application, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access NW.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), and/or LTE-A Pro. However, the scope of the present application should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a ng-eNB as in an Evolved Universal Terrestrial Radio Access (E-UTRA) BS in connection with the 5GC, a next-generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using multiple cells forming the radio access NW. The BS supports the operations of the cells. Each cell is operable to provide services to at least one UE within its radio coverage. More specifically, each cell (often referred to as a serving cell) provides services to serve one or more UEs within its radio coverage (e.g., each cell schedules the downlink (DL) and optionally uplink (UL) resources to at least one UE within its radio coverage for DL and optionally UL packet transmissions). The BS may communicate with one or more UEs in the radio communication system through the plurality of cells. A cell may allocate Sidelink (SL) resources for supporting Proximity Service (ProSe) or Vehicle to Everything (V2X) service. Each cell may have overlapped coverage areas with other cells.

As discussed above, the frame structure for NR is to support flexible configurations for accommodating various next-generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a DL transmission data, a guard period, and an UL transmission data should at least be included, where the respective portions of the DL transmission data, the guard period, and the UL transmission data should also be configurable, for example, based on the NW dynamics of NR. In addition, SL resources may also be provided in an NR frame to support ProSe services or V2X services.

In addition, the terms “system” and “NW” herein may be used interchangeably. The term “and/or” herein is only an association relationship for describing associated objects, and represents that three relationships may exist. For example, A and/or B may indicate that A exists alone, A and B exist at the same time, or B exists alone. In addition, the character “/” herein generally represents that the former and latter associated objects are in an “or” relationship. Multiple PLMNs may operate on the unlicensed spectrum. Multiple PLMNs may share the same unlicensed carrier. The PLMNs may be public or private. Public PLMNs may be (but not limited to) the operators or virtual operators, which provides radio services to the public subscribers. Public PLMNs may own the licensed spectrum and support the radio access technology on the licensed spectrum as well. Private PLMNs may be (but not limited to) the micro-operators, factories, or enterprises, which provides radio services to its private users (e.g., employees or machines). In some implementations, public PLMNs may support more deployment scenarios (e.g., carrier aggregation between licensed band NR (PCell) and NR-U (SCell), dual connectivity between licensed band LTE (PCell) and NR-U (PSCell), stand-alone NR-U, an NR cell with DL in unlicensed band and UL in licensed band, dual connectivity between licensed band NR (PCell) and NR-U (PSCell)). In some implementations, private PLMNs mainly support (but not limited to) the stand-alone unlicensed radio access technology (e.g., stand-alone NR-U).

Some of the terms, definitions, and abbreviations, as given in this disclosure, are either found in existing documentation (European Telecommunications Standards Institute (ETSI), International Telecommunication Union (ITU), etc.) or may have been newly created by the 3GPP experts, for example, in the case that there was a need for a precise vocabulary.

The New Radio (NR) cellular wireless communication system has been conducted by the 3rd Generation Partnership Project (3GPP), as a representative of the worldwide fifth-generation (5G) mobile network. By introducing several mechanisms, the NR is distanced from the 4^{th} generation mobile networks (e.g., 3GPP LTE) with regards to performance, flexibility, scalability, and radio resource efficiency aspects. NR supports various types of services in particular frequency ranges. These services may include Enhanced Mobile BroadBand (eMBB), Ultra-reliable and Low-latency Communications (URLLC), and Massive Machine Type Communications (mMTC). Furthermore, in the 3GPP Release 18, extended reality (XR) traffic may be supported by NR. The latency requirement of XR traffic in the Radio Access Network (RAN) may be modelled as Packet Delay Budget (PDB) and/or PDU Set Delay Budget (PSDB).

In order to ensure the Quality of Service (QoS) requirement of the extended reality (XR) application in the NR wireless communication system, a gNB may need to schedule the XR specific downlink (DL) data and grant uplink (UL) resources for a UE timely to ensure the tight delay requirement of the XR traffic. However, it is a challenge for a gNB to guarantee the delay requirement for particular services due to limited radio resource while improving the radio resource utilization. One potential way to improve the radio resource utilization is to let the gNB be aware of the information related to the packet delay budget for corresponding services or data. Once the gNB has such PDB information, the scheduler may prioritize data to be transmitted with less PDB. However, currently, in NR, when UE has the data that is ready to transmit stored in a buffer, the UE may only request for the UL resources without letting the gNB know of the corresponding PDB. The UL resource request mechanism may need to be improved for carrying delay information, such as the PDB.

From the gNB's perspective, having buffer information is not very efficient. Instead, having the buffer and delay information for a particular PDU set may be much more effective (e.g., from a capacity point of view), and as such, the gNB may allocate resources accurately when taking into account the delay for the given PDU set.

In some implementations, the PDB may be defined as a limited time budget for a packet to be transmitted over the air (e.g., RAN), for example, from a gNB to a UE (e.g., via Downlink (DL)) or from a UE to a gNB (e.g., via Uplink (UL)). For a DL packet, the delay incurred in the air interface may be measured from the time that the packet arrives at the gNB to the time that it is successfully transmitted to the UE. For a UL packet, the delay incurred in air interface is measured from the time that the packet arrives at the UE to the time that it is successfully transmitted to the gNB. If the delay (e.g., any of the two delays described above) is larger than the PDB of the packet, the packet is determined as to have violated the PDB, otherwise, the packet is considered as to have been successfully transmitted. The value of the PDB may vary for different applications and traffic types.

Similar to the definition of the PDB, the PSDB may be defined as a limited time budget for all the PDUs belonging to a PDU set to be transmitted over the air (e.g., RAN), for example, from a gNB to a UE, or from a UE to a gNB. A PDU set may be defined as a set of packets (e.g. data packets or IP packets) that may have dependency on each other.

For example, a PDU set may include data packets of a video frame that are required to decode the video. Such PDU set may require a common QoS treatment within the NR. Considering that each data packet within an XR PDU set (e.g., a video frame) is dependent on the other packets and may be received within the expected PDB, the PDU set may imply that data packets should no longer be treated independently in the RAN.

In the NR wireless communication system, once a UE does not have enough UL resources for a data transmission, the UE may ask a gNB to provide the UL resources. That is, the UE may transmit a UL resource request to the gNB, and the gNB, in response, may schedule certain amount of UL resources for the UE. The UE which transmits the UL resource request may be in an RRC_CONNECTED state (e.g., RRC Connected state) or other states. For example, the request by a UE in the RRC_CONNECTED state may be transmitted on a PUSCH that is scheduled by either a dynamic grant (DG) or a configured grant (CG). The request by a UE in an RRC_IDLE state or an RRC_INACTIVE state may be transmitted on a PUSCH scheduled by a Random Access Response (RAR) or a preconfigured PUSCH associated with a PRACH (e.g., in a 2-step RA).

The dynamic grant may be indicated by the downlink control information (DCI) transmitted by the gNB on a PDCCH, and the DCI may be found in a PDCCH via blind decoding. Specifically, the UE may be configured with a set of PDCCH candidates within one or more CORESET(s). The set of PDCCH candidates for the UE to monitor may be defined in terms of PDCCH search space sets (may also be referred to as search space sets).

A search space set may be categorized into two types, a Common Search space (CSS) set or a UE Specific Search Space (USS) set. That is, a UE may monitor the PDCCH candidates according to one or more configured search space sets to decode a possible PDCCH transmitted by the gNB. In other words, a PDCCH may be found among the PDCCH candidates within the monitored search space sets. Specifically, the UE may monitor a set of PDCCH candidates in one or more CORESETs and/or Search Spaces on a DL BWP (e.g., the active DL BWP on each activated serving cell or the initial BWP on a camped cell) configured with PDCCH monitoring according to corresponding search space sets. Said monitoring may imply the decoding of each PDCCH candidate according to the monitored DCI formats. That is, the DCI with the CRC bits scrambled by the UE specific RNTI (e.g., C-RNTI) may be carried by the PDCCH, and the DCI may be founded by the UE descrambling the CRC bits with the RNTI.

The UE may monitor the PDCCH candidates within one or more CORESET. A CORESET may be represented as a specific radio resource indicated by the gNB via one or more parameters included in one or more configurations (e.g., the ControlResourceSet information element (IE)). The one or more parameters and/or configurations may be transmitted by the gNB to the UE via a broadcast system information block (SIB) or dedicated (unicast) signaling. It may be assumed that a CORESET has a particular width in the frequency domain as well as a particular width in the time domain, and that the widths may be indicated by the ControlResourceSet IE.

In the time domain, the CORESET may be periodically appeared (e.g., in a manner allocated/configured by the gNB). The exact positions of the CORESET(s) in the time domain may be preconfigured by the gNB to the UE through a SearchSpace IE. Each ControlResourceSet may be indexed with a CORESET ID carried by the ControlResourceSet IE itself. Similarly, each SearchSpace may be indexed with a SearchSpace ID carried by the SearchSpace IE itself. Meanwhile, each of the configured SearchSpace IEs may be associated with one ControlResourceSet IE and the association may be indicated through the SearchSpace IE. Hence, by providing the associated ControlResourceSet IE and SearchSpace IE to UE, the gNB may indicate the CORESET to the UE for the PDCCH monitoring. Each search space may be further categorized as a CSS or a USS, and the categorization may be indicated by the gNB to the UE via the corresponding SearchSpace. The UE may be indicated with multiple search spaces, each of which may be indicated by the gNB for different purposes, for example, a SearchSpace for a purpose of random access and another SearchSpace for a purpose of a normal data transmission/reception assignment.

A UE may transmit a request to a gNB for requesting UL resource(s). The request transmitted by the UE to the gNB may be represented by a particular UL signal, and the UL signal may include, but is not limited to, a Control Element (CE) of the Media Access Control (MAC) layer (e.g., a MAC CE). The MAC CE may carry one or more particular types of information. Each type of information may be indicated by a particular field of the MAC CE. For example, the MAC CE may carry the amount of UL resource(s) which is expected by the UE via a particular type(s) of field(s). For example, the MAC CE may carry the amount of data that is in the buffer of a UE and that is ready for transmission (e.g., via a Buffer Status Report (BSR)). The amount of data in the buffer of the UE which is ready for transmission may be referred to as the Buffer Size. The buffer may include multiple buffers implemented in at least one of the UE's MAC, Radio Link Control (RLC), and/or Packet Data Control Protocol (PDCP) layers. The MAC CE that carries such data may be referred to as a BSR MAC CE. That is, the BSR may refer to the data that is buffered for a group of logical channels (e.g., a logical channel group (LCG)) in the UE. A BSR MAC CE may include one or more BSRs associated with a MAC entity of the UE. Generally, a UE may be configured, for example, by the gNB via RRC signaling, with more than one Logical Channel (LCH) and each LCH may be associated with a different application (e.g., QoS flow). Each LCH may be configured, by the gNB via RRC signaling, to belong to an LCG. In NR, a UE may be configured with up to 32 LCHs and up to 8 LCGs.

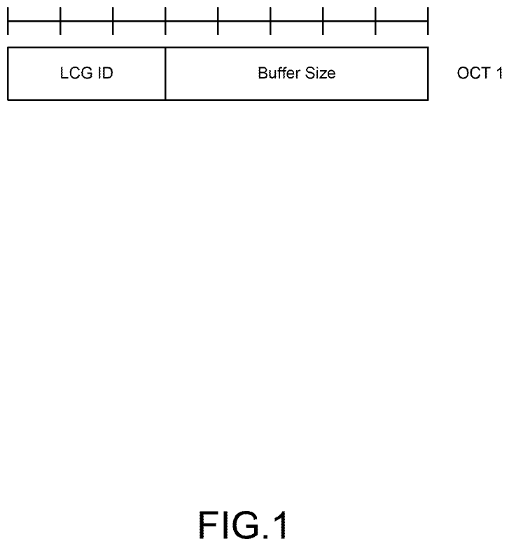

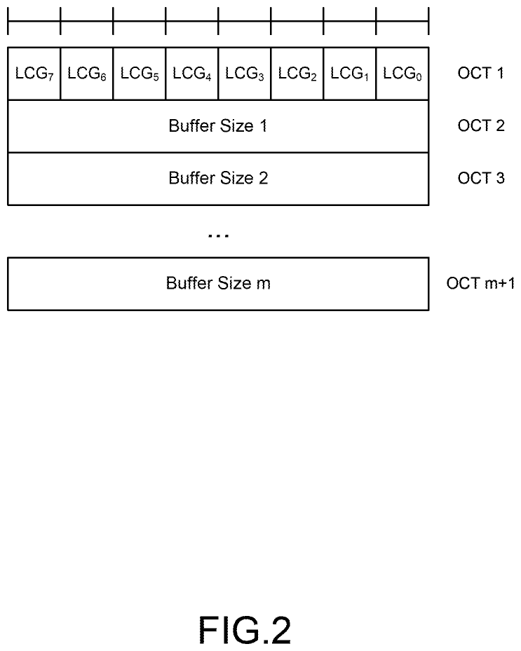

FIG. 1 is a diagram illustrating a format of a BSR MAC CE, according to an example implementation of the present disclosure. FIG. 2 is also a diagram illustrating a format of a BSR MAC CE, according to an example implementation of the present disclosure.

Depending on the number of BSRs that are needed to be transmitted by a UE, different formats of the BSR MAC CE may be applied. A Short BSR format (fixed size) and a Short Truncated BSR format (fixed size) may be defined as shown in FIG. 1. A Long BSR format (variable size) and a Long Truncated BSR format (variable size) may be defined as shown in FIG. 2.

Several types of fields in each format of the BSR MAC CE may be defined as follows:
LCG ID: The LCG ID field may identify the group of logical channel(s) the buffer status of which is being reported.
LCGᵢ: For the Long BSR format, this field may indicate the presence of the Buffer Size field for the logical channel group i. For example, the LCGᵢ field set to 1 may indicate that the Buffer Size field for the logical channel group i is reported, and the LCGᵢ field set to 0 may indicate that the Buffer Size field for the logical channel group i is not reported. For the long truncated BSR format, this field may indicate whether the logical channel group i has data available. For example, the LCGᵢ field set to 1 may indicate that the logical channel group i has data available, and the LCGᵢ field set to 0 may indicate that the logical channel group i does not have any data available.
Buffer Size: The Buffer Size field may identify the total amount of data available for transmission across all the logical channels of a logical channel group after the MAC PDU has been built (e.g., after the logical channel prioritization procedure, which may result in the value of the Buffer Size field being zero). The amount of data may be indicated in a number of bytes. The size of the RLC headers and MAC sub-header(s) may not be considered in the buffer size computation. The length of this field for different BSR formats may be different. Depending on the length of this field, the values of the Buffer Size fields may be mapped to different buffer size levels. For the Long BSR format and the Long Truncated BSR format, as shown in FIG. 2, the Buffer Size fields may be included in an ascending order, for example, based on the LCGᵢ.

In the following, different implementations of a mechanism which allows the gNB to gather delay information (DI) from the UE for the purpose of enhancing the gNB's scheduler to be a delay aware scheduler are described. The mechanism may include the UE reporting the DI of a particular data packet to the gNB via a UL signal. It should be noted that the DI of a particular data packet may include, but is not limited to, a particular data packet stored in the buffer and ready to be transmitted, or a PDU set as described above. The DI may include, but is not limited to, the PDB and/or PSDB. That is, by implementing the disclosed mechanism, the UE may report, to the gNB, the PDB of the data packet stored in the buffer and ready to be transmitted, or the UE may report the PSDB of a particular PDU set to the gNB.

In some implementations, the PDB may be defined as an upper bound for the time that a data packet may be delayed (e.g., a maximum allowed delay) between the UE and the User Plane Function (UPF) that is terminated at the N6 interface (e.g., a reference point between the UPF and a Data Network).

In some implementations, the PDB may include at least two components, a first component that includes an Access Network-PDB (AN-PDB), and a second component that includes a Core Network-PDB (CN-PDB). The AN-PDB may be defined as an upper bound of the time that a packet may be delayed in the Access Network, while the CN-PDB may be defined as an upper bound of the time that a packet may be delayed in the Core Network.

In some implementations, the delay information, reported by the UE to the gNB for corresponding data, may be represented as either the AN-PDB or the CN-PDB. The PSDB may define an upper bound for the delay that a PDU Set may experience for the transmission between the UE and the N6 termination point at the UPF, e.g., the time between reception of the first PDU (e.g., data packet) and the successful delivery of the last arrived PDU of the PDU Set. The PSDB may be applied to the DL PDU Set received by the UPF over the N6 interface, and to the UL PDU Set sent by the UE. For a certain 5G QoS Identifier (5QI), the value of the PSDB is the same for both UL and DL.

In some implementations, in order to report the DI to the gNB, the DI may be carried by a particular UL signal which may include, but is not limited to, a Delay Report (DR) Media Access Control (MAC) Control Element (CE). The DR MAC CE carrying the DI may include, but is not limited to, a newly introduced MAC CE. In some implementations, the DR MAC CE may include, but is not limited to, a legacy Buffer Status Report (BSR) MAC CE, or an enhanced BSR MAC CE. That is, the DI may be carried by the DR MAC CE. Since the legacy BSR MAC CE does not contain any information about the delay, when the UE needs to report the DI to the gNB via the legacy BSR MAC CE, the format/interpretation of current content, field and/or format of the legacy BSR MAC CE needs to be modified.

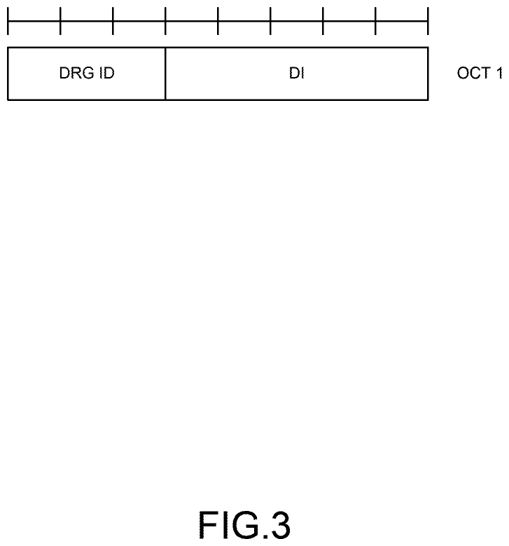

FIGS. 3 to 9 are diagrams of different formats of a DR MAC CE, according to an example implementation of the present disclosure. Multiple formats of the UL MAC CE (e.g., DR MAC CE) will be described with reference to FIGS. 3 to 9. Each type of format of DR MAC CE may be identified with a different logical channel Identity (LCID). Each format is described below:

FIG. 3 is a diagram of illustrating a format of a DR MAC CE, according to an example implementation of the present disclosure.

1) Formats applied for reporting a single DI may include:
Type I Short DR MAC CE, as shown in FIG. 3; and
Type I Short Truncated DR MAC CE, as shown in FIG. 3.

Referring to FIG. 3, each field of the Type I Short DR MAC CE and Type I Short Truncated DR MAC CE may be defined as follows:
DRG ID: For Type I Short DR MAC CE and Type I Short Truncated DR MAC CE, the DI Report Group (DRG) ID field may identify the group of logical channel(s) for which the DI is being reported. In some implementations, the DRG may be one or more logical channels grouped by the gNB for reporting the DI. In other words, a logical channel may be indicated by the gNB as belonging to a DRG for the purpose of DI reporting.
DI: For Type I Short DR MAC CE and Type I Short Truncated DR MAC CE, the DI field may identify the delay information of data of a DRG which is indicated by the DRG ID.

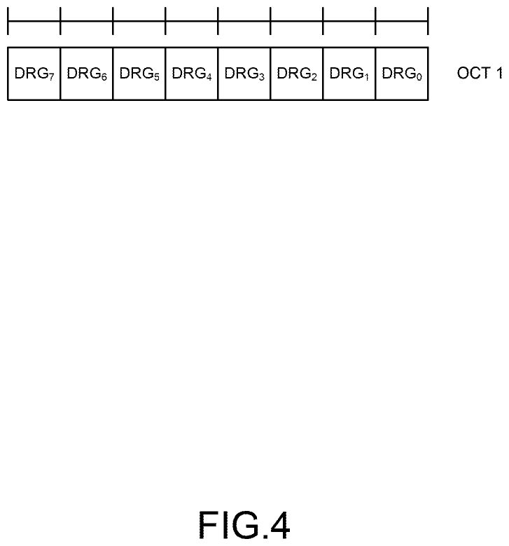

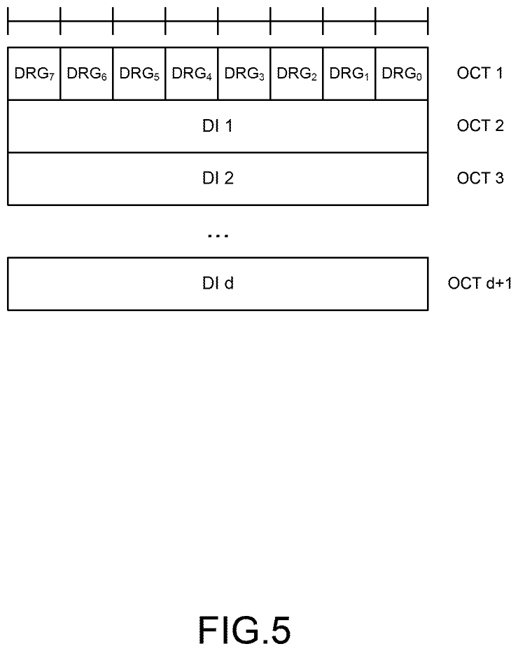

FIG. 4 is a diagram of illustrating another format of a DR MAC CE, according to an example implementation of the present disclosure. FIG. 5 is a diagram of illustrating another format of a DR MAC CE, according to an example implementation of the present disclosure.

2) Formats applied for reporting more than one DI may include:
Type II Short DR MAC CE, as shown in FIG. 4;
Type II Short Truncated DR MAC CE, as shown in FIG. 4;
Long DR MAC CE, as shown in FIG. 5; and
Long Truncated DR MAC CE, as shown in FIG. 5.

In some implementations, the DRG may be implemented as a group of logical channels which are indicated by the gNB for Delay Information reporting.

Referring to FIGS. 4 and 5, each field of the Type II Short DR MAC CE, the Type II Short Truncated DR MAC CE, the Long DR MAC CE, and the Long Truncated DR MAC CE may be defined as follows:
DRGᵢ: For Type II Short DR MAC CE, Type II Short Truncated DR MAC CE, and Long Truncated DR MAC CE, the DRGᵢ field may indicate whether there exists a data packet of the DI Report Group i that satisfies one or more particular conditions. For example, DRGᵢ set to “1” may mean that there is at least one data packet of the DI Report Group i that satisfies at least one of the particular conditions. For example, DRGᵢ set to “0” may mean that there is no data packet of the DI Report Group i that satisfies at least one of the particular conditions.

In some implementations, the particular conditions may include, but are not limited to, a PDB and/or a PSDB of a data packet of the corresponding DI Report Group being equal to or less than a threshold. The threshold may include, but is not limited to, a threshold that is preconfigured by the gNB via RRC signaling.

In some implementations, a data packet of a DI Report Group may be interpreted as the data packet that is associated with a logical channel which is configured as belonging to the DI Report Group.

For the Long DR MAC CE, the DRGᵢ field may indicate whether the DI of the DI Report Group i is reported. For example, the DRGᵢ field set to “1” may indicate that the DI field for the DI Report Group i is reported. For example, the DRGᵢ field set to “0” may indicate that the DI field for the DI Report Group i is not reported.
DI: For the Long DR MAC CE and the Long Truncated DR MAC CE, a DI field may identify the delay information of the data of the DI Report Group i, which is indicated by the DRGᵢ. The DI fields may be included in an ascending, or a descending, order based on the DRGᵢ. For example, among all the DI Report Groups that the DRGᵢ field is set to “1”, a first DI field may be included for a DI Report Group having the smallest value of i, and a second DI field may be included for a DI Report Group having the second smallest value of i, and so on.

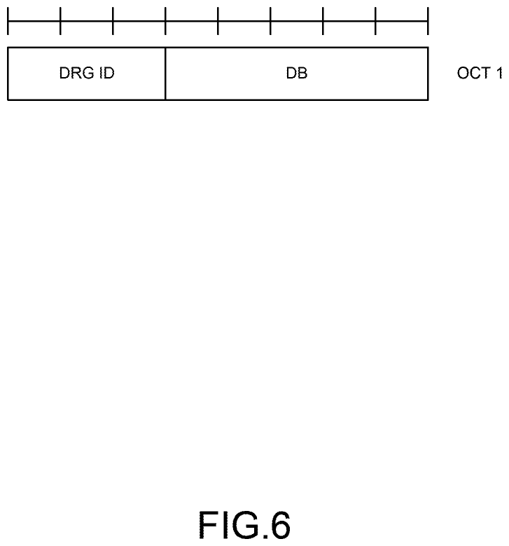

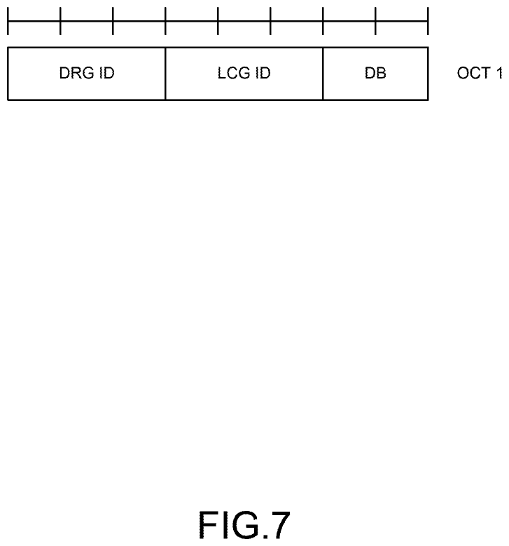

FIG. 6 is a diagram of illustrating another format of a DR MAC CE, according to an example implementation of the present disclosure. FIG. 7 is a diagram of illustrating another format of a DR MAC CE, according to an example implementation of the present disclosure.

3) Formats applied for reporting a single DB may include:
Type I Short Hybrid DR MAC CE, as shown in FIG. 6;
Type I Short Hybrid Truncated DR MAC CE, as shown in FIG. 6;
Type II Short Hybrid DR MAC CE, as shown in FIG. 7; and
Type II Short Hybrid Truncated DR MAC CE, as shown in FIG. 7.

Referring to FIGS. 6 and 7, each field of the Type I Short Hybrid DR MAC CE, the Type I Short Hybrid Truncated DR MAC CE, the Type II Short Hybrid DR MAC CE, and the Type II Short Hybrid Truncated DR MAC CE may be defined as following:
DRG ID: The DRG ID field may identify a group of logical channel(s) which Delay Information and Buffer Status are being reported.

In some implementations, the DRG may include, but is not limited to, one or more logical channels grouped by the gNB for reporting the DI. In other words, a logical channel may be indicated by the gNB as belonging to a DRG for the purpose of the DI and Buffer status reporting.
LCG ID: For the Type II Short Hybrid DR MAC CE and the Type II Short Hybrid Truncated DR MAC CE, the LCG ID field may identify the group of logical channel(s) for which the Delay Information and Buffer Status are being reported.

In some implementations, the logical channel(s) identified by the DRG ID may be different from the logical channel(s) identified by the LCG ID.
DB: The DB field may identify the Delay Information of data of a DI Report Group which is indicated by the DRG ID. The DB field may also identify the total amount of data available for transmission across all logical channels of a logical channel group indicated by the LCG ID.

In some implementations, the DB field may indicate both the Delay Information and the Buffer Status based on one or more mapping tables. The mapping table(s) may be pre-defined or pre-configured by the gNB via RRC signaling. The mapping table(s) may define the mapping between index values, Delay Information, and the Buffer Size. That is, based on the mapping table a value of the DB may be mapped to at least Delay Information and a Buffer Size.

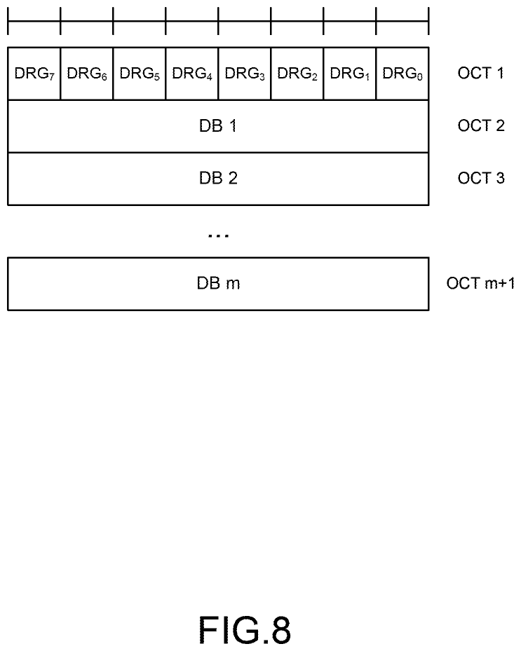

FIG. 8 is a diagram of illustrating another format of a DR MAC CE, according to an example implementation of the present disclosure.

4) Formats applied for reporting more than one DB may include:
Type I Long Hybrid DR MAC CE, as shown in FIG. 8; and
Type I Long Hybrid Truncated DR MAC CE, as shown in FIG. 8.

Referring to FIG. 8, each field of the Type I Long Hybrid DR MAC CE and the Type I Long Hybrid Truncated DR MAC CE may be defined as follows:
DRGᵢ: For the Type I Long Hybrid DR MAC CE, the DRGᵢ field may indicate whether there exists a data packet of the DI Report Group i that satisfies one or more particular conditions. For example, a DRGᵢ set to “1” may mean that there is at least a data packet of the DI Report Group i satisfies at least one of the particular conditions. In opposite, a DRGᵢ set to “0” may mean that there is no data packet of the DI Report Group i satisfies the particular conditions.

In some implementations, the particular conditions may include, but is not limited to, a PDB and/or a PSDB of a data packet of the corresponding DI Report Group being equal to or less than a threshold. The threshold may include, but is not limited to, a threshold preconfigured by the gNB via RRC signaling.

In some implementations, a data packet of a DI Report Group may be interpreted as the data packet being associated with a logical channel which is configured to be belonging to the DI Report Group.

For the Type I Long Hybrid Truncated DR MAC CE, the DRGᵢ field may indicate whether the DI of the DI Report Group i is reported. For example, the DRGᵢ field set to “1” may indicate that the DI field for the DI Report Group i is reported. For example, the DRGᵢ field set to “0” may indicate that the DI field for the DI Report Group i is not reported.
DB: The DB field may identify the Delay Information of data of a DI Report Group which is indicated by the DRG ID. The DB field may also identify the total amount of data available for transmission across all logical channels of a logical channel group indicated by the DRG ID.

In some implementations, the DB field may indicate both the Delay Information and the Buffer Status based on one or more mapping tables. The mapping table(s) may be pre-defined or pre-configured by the gNB via RRC. The mapping table may define the mapping between the index values, the Delay Information, and the Buffer Size. That is, based on the mapping table, a value of the DB may be mapped to at least Delay Information and a Buffer Size.

For the Type I Long Hybrid DR MAC CE and the Type I Long Hybrid Truncated DR MAC CE, the DB fields may be included in an ascending, or a descending, order based on the DRGᵢ. For example, among all the DI Report Groups that the DRGᵢ field is set to “1”, a first DB field may be included for a DI Report Group having the smallest value of i, and a second DB field may be included for a DI Report Group having the second smallest value of i, and so on.

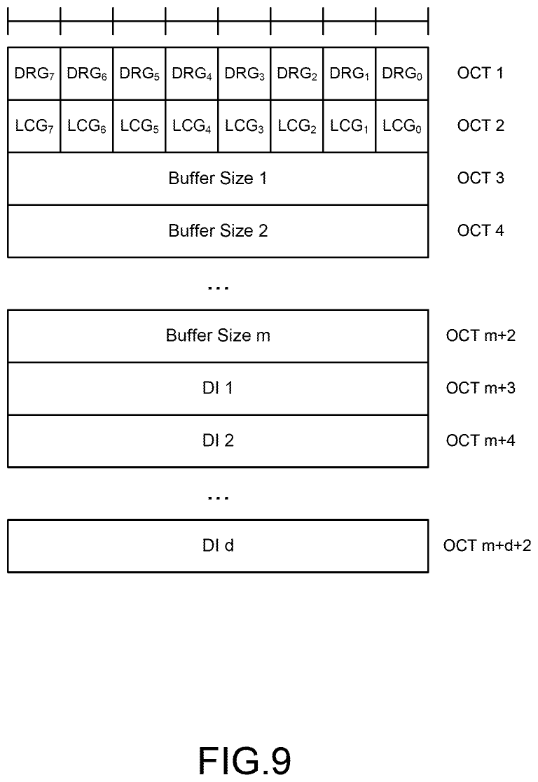

FIG. 9 is a diagram of illustrating another format of a DR MAC CE, according to an example implementation of the present disclosure.

5) Formats applied for reporting more than one DI and more than one Buffer Size may include:
Type II Long Hybrid DR MAC CE, as shown in FIG. 9; and
Type II Long Hybrid Truncated DR MAC CE, as shown in FIG. 9.

Referring to FIG. 9, each field of the Type II Long Hybrid DR MAC CE and the Type II Long Hybrid Truncated DR MAC CE may be defined as follows:
DRGᵢ: For the Type II Long Hybrid DR MAC CE, the DRGᵢ field may indicate whether there exists a data packet of the DI Report Group i that satisfies one or more particular conditions. For example, a DRGᵢ set to “1” may mean that there is at least a data packet of the DI Report Group i that satisfies at least one of the particular conditions. In opposite, a DRGᵢ set to “0” may mean that there is no data packet of the DI Report Group i that satisfies the particular conditions.

In some implementations, the particular conditions may include, but are not limited to, a PDB and/or a PSDB of a data packet of the corresponding DI Report Group being equal to or less than a threshold. The threshold may include, but is not limited to, a threshold preconfigured by the gNB via RRC signaling.

In some implementations, a data packet of a DI Report Group may be interpreted as the data packet being associated with a logical channel which is configured to be belonging to the DI Report Group.

For the Type II Long Hybrid Truncated DR MAC CE, the DRGᵢ field may indicate whether the DI of the DI Report Group i is reported. For example, a DRGᵢ field set to “1” may indicate that the DI field for the DI Report Group i is reported. For example, the DRGᵢ field set to “0” may indicate that the DI field for the DI Report Group i is not reported.
LCGᵢ: For the Type II Long Hybrid DR MAC CE, the LCGᵢ field may indicate the presence of the Buffer Size field for the logical channel group i. For example, the LCGᵢ field set to 1 may indicate that the Buffer Size field for the logical channel group i is reported. For example, the LCGᵢ field set to 0 may indicate that the Buffer Size field for the logical channel group i is not reported. For the Type II Long Hybrid Truncated DR MAC CE, the LCGᵢ field may indicate whether the logical channel group i has data available. For example, the LCGᵢ field set to 1 may indicate that the logical channel group i has data available. For example, the LCGᵢ field set to 0 may indicate that the logical channel group i does not have any data available.
Buffer Size: The Buffer Size field may identify the total amount of data available for transmission across all logical channels of a logical channel group after the MAC PDU has been built (e.g., after the logical channel prioritization procedure, which may result in the value of the Buffer Size field being zero). The amount of data may be indicated in number of bytes. The size of the RLC headers and MAC sub-header(s) may not be considered in the buffer size computation. The length of this field for different BSR formats may be different. Depending on the length of this field, the values for the Buffer Size fields may be mapped to different buffer size levels. For the Type II Long Hybrid DR MAC CE and the Type II Long Hybrid Truncated DR MAC CE, the Buffer Size fields may be included in an ascending order based on the LCGᵢ.
DI: For the Type II Long Hybrid DR MAC CE and the Type II Long Hybrid Truncated DR MAC CE, a DI field may identify the delay information of data of a DI Report Group i which is indicated by DRGᵢ. The DI fields may be included in an ascending, or a descending, order based on the DRGᵢ. For example, among all the DI Report Groups that the DRGᵢ field is set to “1”, a first DI field may be included for a DI Report Group having the smallest value of i, and a second DI field may be included for a DI Report Group having the second smallest value of i, and so on.

In some implementations, a first LCH x in an LCG may have a higher priority than a second LCH y in a DRG, where the first LCH x may have no delay information to be reported and the second LCH y may have delay information to be reported. When the UL resource is insufficient for including all the required buffer size fields and the DI fields, the UE may need to determine whether to include the buffer size field for the first LCH or the DI field for the second LCH. Specifically, for the Type II Long Hybrid Truncated DR MAC CE, the UE may jointly consider which of the buffer size fields for an LCH in an LCG and the DI fields for an LCH in a DRG may be included in a specific/configured order. In some implementations, the order may be the legacy priority for LCHs. In case of equal priority, the order may be an ascending order of the LCG ID or an ascending order of the DRG ID.

Each format of the DR MAC CE may contain one or more fields indicating information related to the DI. In some implementations, a DR MAC CE may not only contain one or more newly defined fields but also it may contain one or more fields defined for the legacy BSR MAC CE. It should be noted that the one or more newly defined fields may be applied by the UE to carry the DI, and the one or more fields defined for the legacy BSR MAC CE may include, but are not limited to, the LCG ID, the LCGᵢ, and/or the Buffer Size fields.

In some implementations, once the UE executes the delay information reporting via a MAC CE (e.g., a DR MAC CE), the following two scenarios may take place.

Regarding the first scenario, once the LCG ID, the LCG, the Buffer Size, and the DI field are all carried in the DR MAC CE, the size of the DR MAC CE may increase significantly. As such, more UL resources granted by the gNB may be consumed. Hence, it is challenging to keep the size of the DR MAC CE small while keeping the additionally provided delay information as accurate as possible.

Regarding the first scenario, the DR MAC CE may contain at least a new type of field: Delay Information (DI). A value, indicated by the DI field, may be associated with at least the delay information. By carrying the DI field in the MAC CE, the UE may report the delay information to the gNB. The association between the value of the DI field and the delay information may be based on one or more pre-defined/pre-configured mapping tables. Each mapping table may include at least the mapping between multiple values of the DI field and multiple pieces of delay information.

In some implementations, the DI field may be defined as a bitmap. According to the mapping table, each value indicated by the DI field may be associated with a delay value or a range of delay values.

In some implementations, a UE may be configured with multiple mapping tabless, and one of the configured mapping tables may be determined and applied by the UE. The determination may be made according to at least one of the number of LCHs/LCGs needed to report the delay information and the number of UL resources to be applied for transmitting the MAC CE. In some implementations, one or more pre-defined mapping tables may be implemented. For example, in a case that the UE is not configured by the gNB with a mapping tabless, the UE may apply the pre-defined mapping table(s). However, which of the pre-defined mapping table(s) to be applied by the UE may be determined based on at least one of the number of LCHs/LCGs needed to report the delay information and the number of UL resources to be applied for transmitting the MAC CE.

In some implementations, the MAC CE may carry a newly defined field for indicating whether the UE has data in the buffer for transmission and whether the transmission of data is urgent. For example, data that is urgent may be interpreted as the data's PDB reaching a particular threshold. For example, the particular threshold may be a pre-defined value or pre-configured by the gNB. That is, instead of reporting detailed information of the delay (e.g., via a PDB) to the gNB, the UE may indicate to the gNB, via the MAC CE, whether the data of the LCH/LCG is urgent or not.

Regarding the second scenario, a UE may be configured with multiple LCHs, each being associated with a different application (e.g., different QoS flows), and only a specific part of the LCHs is configured to be associated with the XR application. In this case, the delay information may only be reported by the UE for the specific part of the LCHs. That is, the remaining part of the LCHs may be configured to be associated with the non-XR application which may not be associated with the PDU set characteristic, as described above. Hence, how to report the delay information and buffer size information via a MAC CE simultaneously may become quite complicated. Hence, it is challenging for the gNB to determine which LCH is associated with the delay information carried by the MAC CE.

In some implementations, the MAC CE may carry multiple DI fields. Each DI field may be associated with an LCH or an LCG. The LCG may be a group of logical channels configured for the BSR reporting, as legacy, or a group of logical channels configured for the delay information reporting. For example, a DI associated with an LCH i or an LCGᵢ may be denoted as DIᵢ in the MAC CE.

In some implementations, the MAC CE may carry multiple DI fields. Each DI field may be associated with an LCH or an LCG. The LCG may be a group of logical channels configured by the gNB for the BSR reporting, as legacy, or a group of logical channels configured by the gNB for delay information reporting. The MAC CE may carry another type of field indicating whether a DI field associated with a specific LCH or LCG is carried in the MAC CE, for example, another type of field may be used to indicate the Presence of DIᵢ (e.g., PDIᵢ). That is, whether a DI associated with an LCH i (e.g., LCGᵢ) or an LCG i (e.g., LCGᵢ) carried in the MAC CE may be indicated by the PDIᵢ. For example, the PDIᵢ set to a first particular value (e.g., “1”) may indicate that a DI associated with the LCH i or the LCG i is carried in the MAC CE, and the PDIᵢ set to a second particular value (e.g., “0”) may indicate a DI associated with the LCH i or the LCG i is not carried in the MAC CE.

In some implementations, the PDIᵢ carried in different formats of the MAC CE may have different definitions. For example, once a particular type of MAC CE is determined by the UE to be applied due to the UE's UL resource is not being enough to carry the DI for all of the LCH(s) or LCG(s) that need to report DI, the PDIᵢ in the particular type of MAC CE may be defined as whether the LCH i or LCG i has the DI that needs to be reported.

In some implementations, when the UE's UL resource is not enough to carry the DI for all of the LCH(s) or LCG(s) that need to report the DI, or the UE's UL resource is not enough to carry the DI and Buffer Size for all of the LCH(s) or LCG(s) that need to report the Buffer Size and the DI, the UE may prioritize carrying the DI field over the Buffer Size field. Taking a UE configured with 8 LCGs (e.g., LCG 1, LCG 2, . . . , LCG 8), as an example, in a case that the UE needs to report the Buffer Size for LCG 1, LCG 2 and LCG 3, and the DI for LCG 1, but the UL resource of the UE is not available for transmitting a particular format of MAC CE to carry all of the Buffer Size of LCG 1, the Buffer Size of LCG 2, the Buffer Size of LCG 3, and the DI of LCG 1, the UE may apply a second format of the MAC CE which may be transmitted by the UL resource. In the second format of the MAC CE, the UE may set the LCG₁, LCG₂, and LCG₃ to “1” to indicate to the gNB that the LCG 1, LCG 2, and LCG 3 have the Buffer Size to report, and may set PDIᵢ to “1” to indicate to the gNB that the LCG 1 has the DI to be reported. That is, depending on the actual size of the second format of the MAC CE (e.g., by considering the amount of UL resource to be applied for transmitting the another format of MAC CE), DI₁ may be prioritized to be included over the buffer size fields of the LCG 1, LCG 2, and LCG 3. In addition, the buffer size fields of LCG 1, LCG 2, and LCG 3 may be included in an ascending order based on the LCGᵢ.

In some implementations, a particular LCG ID may indicate which LCG is urgent.

In some implementations, the UE may be configured/pre-defined with a mapping table which has a mapping between a list of indexes and a list of values. The list of values may define combined information for both the delay information and the buffer size.

As described above, a PDU set may include a set of packets that have dependency on each other and may need to be decoded together. Considering that each packet within an XR PDU set (e.g., a video frame) is dependent on other packets and may be received within the expected PDB, it may not be clear how the PDB should be interpreted and indicated in the MAC CE.

For a DL XR traffic, the latency requirement of the XR traffic in the RAN side (e.g., air interface) may be modelled as a PDB. The PDB may be a limited time budget for a packet to be transmitted over the air from a gNB to a UE. That is, for a given packet, the delay of the packet incurred in an air interface may be measured from the time that the packet arrives at the gNB to the time that the packet is successfully transmitted to the UE. If the delay is larger than a given PDB for the packet, the packet may be determined as to have violated the PDB, otherwise, the packet may be considered as to have been successfully delivered.

For a UL XR traffic, the PDB may be a limited time budget for a packet to be transmitted over the air from a UE to a gNB. That is, for a given packet, the delay of the packet incurred in an air interface may be measured from the time that the packet arrives at the UE to the time that the packet is successfully transmitted to the gNB. If the delay is larger than a given PDB for the packet, the packet may be determined as to have violated the PDB; otherwise, the packet may be considered as to have been successfully delivered. It should be noted that the PDB, as mentioned above may be an AN-PDB.

In a legacy BSR procedure, the Buffer Size may be reported by the UE on a per LCG basis. That is, each reported Buffer Size in the BSR MAC CE may be presented as a total size of the data packet in the buffer for all the LCHs belonging to an LCG. That is, the UE may add up the size of each data packet in each buffer associated with all the LCHs belonging to an LCH, for determining the value of the Buffer Size field. However, it may not be clear how the delay information carried by the MAC CE may be interpreted. A UE may identify a PDB by the upper layer (e.g., application layer), and each packet stored in the buffer may have different PDBs. It may be also not clear how multiple PDBs may be reported by the MAC CE.

In some implementations, the UE may determine a PDB per LCG to be carried in the MAC CE. Specifically, the UE may determine a PDB for each LCG that is associated with the XR traffic and that at least one LCH thereof has data stored in the buffer ready to be transmitted.

In some implementations, for an LCG that is associated with the XR traffic and that at least one LCH thereof has data stored in the buffer ready to be transmitted, the UE may determine a PDB to be carried by the MAC CE according to the value of each PDB of each LCH.

For example, the UE may determine to report a smallest value of PDB among the PDBs of all the LCHs.

For example, the UE may be configured with LCH 1, LCH 2, LCH 3, and LCH 4, where the LCH 1 and LCH 2 may belong to LCG 1, while the LCH 3 and LCH 4 may belong to LCG 2. In one example, LCH 1 and LCH 2 are associated with the XR traffic. In a case that the UE needs to report the Buffer Size of LCG 1, and the PDB of packets belonging to LCH 1 is x and the PDB of packets belonging to LCH 2 is y. The UE, in this example, may determine to report x or y, as the delay information of LCG 1. The UE may make this determination by selecting a smaller value among x and y. In a case that the UE needs to report the Buffer Size of LCG 1, and there may be multiple packets in the buffer and associated with LCH 1 and there may be multiple packets in the buffer and associated with LCH 2. The PDBs of packets belonging to LCH 1 are ×1 and ×2 and the PDBs of packets belonging to LCH 2 are y1 and y2. The UE may select a smaller value among ×1 and ×2, and select a smaller value among y1 and y2. Afterwards, the UE may compare the two selected values, and report the smaller value among the two selected values.

A UE may be configured, by the gNB, via RRC signaling, with multiple LCHs, and each LCH may be associated with a different QoS flow. Each LCH may be configured, by the gNB, via RRC signaling, to be belonging to an LCG. Once a buffer status report is triggered, the UE may need to determine the format of the BSR MAC CE for the buffer status report. That is, the UE may determine a type of field(s) that needs to be included in the BSR MAC CE. In addition, the UE may determine the value of each field by referring to one or more mapping tables.

Once at least one LCH is configured by the gNB to be associated with the XR traffic, the determination of whether a buffer status report is triggered may include whether there is a packet stored in the buffer and whether the PDB of the packet matches one or more particular conditions. In some examples, when at least one data packet store in an LCH of a particular LCG exceeds the PDB threshold (e.g., the PDB of the data packet equal to or lower than a threshold), a particular type of buffer status report may be triggered. In some examples, once a MAC CE has been generated, the MAC CE may carry a buffer size field of a particular LCG and the MAC CE may be transmitted by the UE. After the MAC CE is transmitted, and at least one data packet stored in an LCH of the particular LCG exceeds the PDB threshold (e.g., the PDB of the data packet equal to or lower than a threshold), a particular type of buffer status report may be triggered.

In some implementations, the type of the applied BSR MAC CE (e.g., the field(s) to be included in the BSR MAC CE) may be determined by the UE according to at least one of: the number of LCG(s) having data ready to be transmitted, the number of LCHs/LCGs having data exceeding the PDB threshold, and the number of UL resource(s) for transmitting the BSR MAC CE.

In legacy, all the BSRs triggered prior to the MAC PDU assembly may be cancelled when a MAC PDU is transmitted and the transmitted MAC PDU includes a Long, Extended Long, Short, or Extended Short BSR MAC CE, which contains the buffer status up to the last event that triggered a BSR prior to the MAC PDU assembly.

In some implementations, a triggered BSR/DR, including the delay information for one or more LCHs, may be cancelled when the delay information is out of date. In some implementations, if one data packet stored in an LCH of a particular LCG violates the PDB, a BSR/DR triggered by the LCH may be cancelled.

In some implementations, the PDB may be interpreted as the PDU Set Delay Budget (PSDB).

In some implementations, the DI may be interpreted as the PSDB.

In some implementations, in response to a triggered DI report, a UE may initiate a DI reporting procedure. That is, the UE may determine whether to initiate the DI report. The UE may determine to initiate the DI report when one or more of the following conditions are satisfied:
At least one UL grant received by the UE, and the at least one UL grant has padding bits after considering all available data for transmission in a Logical Channel Prioritization (LCP) procedure. That is, there is still room/resource unused in the UL resource granted by the UL grant, so the UE may add a DR MAC CE for reporting the DI information and/or the Buffer status;
The PDB of a data packet and/or the PSDB of a PDU set reaches a particular threshold. For example, the PDB and/or the PSDB is equal to or less than a particular threshold. The particular threshold may be pre-defined or pre-configured by the gNB;
There is a data packet in the buffer ready to be transmitted in either an RLC or a PDCP buffer, and the data packet belongs to a logical channel having a higher priority than other logical channels having data that triggers a DI report;
There is a data packet in the buffer ready to be transmitted in either an RLC or a PDCP buffer, and the data packet belongs to a DI Report Group having a higher priority than other DI Report Group having data that triggers a DI report;
A BSR has been triggered while no DI report has been triggered, and the remaining UL resource(s) of the UL grant may accommodate either a Type I Long Hybrid DR MAC CE or a Type II Long Hybrid DR MAC CE. The UE may trigger a DI report accordingly, and the UE may apply either the Type I Long Hybrid DR MAC CE or the Type II Long Hybrid DR MAC CE for the corresponding DI reporting and Buffer Size reporting.

In some implementations, there may be at least 14 formats of the DR MAC CE. Once the UE needs to perform the DI reporting, the applied format may depend on one or more conditions.
The UE may select the Type I Short DR MAC CE when at least one of the following conditions is satisfied:
a) A DI report has been triggered;
b) A DI report has been triggered and no BSR has been triggered; and
c) Only one of the LCH, LCG, and DRG has data packet for which the PDB and/or the PSDB needs to be reported.
The UE may select the Type I Short Truncated DR MAC CE when at least one of the following conditions satisfied:
a) A DI report has been triggered;
b) A DI report has been triggered and no BSR has been triggered; and
c) More than one of the LCH, LCG and DRG have data packet of which the PDB and/or the PSDB needs to be reported, and the size of padding bits is smaller than the Long DR MAC CE and the Long Truncated DR MAC CE.

The UE may select the Type II Short DR MAC CE when at least one of the following conditions satisfied:
a) A DI report has been triggered;
b) A DI report has been triggered and no BSR has been triggered; and
c) More than one of the LCH, LCG and DRG have data packet of which the PDB and/or the PSDB needs to be reported, and the size of padding bits is smaller than the Long DR MAC CE and the Long Truncated DR MAC CE.

The UE may select the Type II Short Truncated DR MAC CE when at least one of the following conditions satisfied:
a) A DI report has been triggered;
b) A DI report has been triggered and no BSR has been triggered; and
c) More than one of the LCH, LCG and DRG have data packet of which the PDB and/or the PSDB needs to be reported, and the size of padding bits is smaller than the Long DR MAC CE and the Long Truncated DR MAC CE.

The UE may select the Long DR MAC CE when at least one of the following conditions satisfied:
a) A DI report has been triggered;
b) A DI report has been triggered and no BSR has been triggered;
c) More than one of the LCH, LCG and DRG have data packet of which the PDB and/or the PSDB needs to be reported; and
d) More than one of the LCH, LCG and DRG have data packet of which the PDB and/or the PSDB needs to be reported, and the size of padding bits is equal to or larger than the Long DR MAC CE.

The UE may select the Long Truncated DR MAC CE when at least one of the following conditions satisfied:
a) A DI report has been triggered;
b) A DI report has been triggered and no BSR has been triggered; and
c) More than one of the LCH, LCG and DRG have data packet of which the PDB and/or the PSDB needs to be reported, and the size of padding bits is smaller than the Long DR MAC CE but larger than the Short DR MAC CE (e.g., the Type I Short DR MAC CE, the Type I Short Truncated DR MAC CE, the Type II Short DR MAC CE, or the Type II Short Truncated DR MAC CE).

It should be noted that a reference signal (RS) ID may be replaced by some other ID that may explicitly or implicitly indicate to the gNB a new beam.

It should be noted that all the designs, embodiments, and implementations introduced in this disclosure may not be limited to be applied for dealing with the problems mentioned within this disclosure. For example, they may be applied to solve any other problem that exists in a radio access network of a cellular wireless communication system.

It should be noted that all the numbers listed within the designs, embodiments, and implementations introduced in this disclosure may include just examples for illustrating how the method may be executed.

It should be noted that the downlink RRC message in the present disclosure may include, but is not limited to, the RRCReconfiguration, the RRCResume, the RRCReestablishment, the RRCSetup, or any other downlink unicast RRC message.

It should be noted that the phrase “a specific configuration is per UE configured” or “a specific configuration is configured for a UE” in this disclosure may mean that the specific configuration may be configured within a downlink RRC message.

It should be noted that the phrase “a specific configuration is per cell group configured” or “a specific configuration is configured for a cell group” in this disclosure may indicate that the specific configuration may be configured within a CellGroupConfig, a MAC-CellGroupConfig, or a PhysicalCellGroupConfig IE.

It should be noted that the phrase “a specific configuration is per serving cell configured” or “a specific configuration is configured for a serving cell” in this disclosure may indicate that the specific configuration may be configured within a ServingCellConfigCommon, a ServingCellConfig, a PUSCH-ServingCellConfig, or a PDSCH-ServingCellConfig IE.

It should be noted that the phrase “a specific configuration is per UL BWP or per BWP configured” or “a specific configuration is configured for a UL BWP or for a BWP” in this disclosure may indicate that the specific configuration may be configured within a BWP-Uplink, a BWP-UplinkDedicated, a BWP-UplinkCommon, a PUSCH-ConfigCommon, or a PUSCH-Config IE.

It should be noted that the phrase “a specific configuration is per DL BWP or per BWP configured” or “a specific configuration is configured for a DL BWP or for a BWP” in this disclosure may indicate that the specific configuration may be configured within a BWP-Downlink, a BWP-DownlinkDedicated, a BWP-DownlinkCommon, a PDSCH-ConfigCommon, or a PDSCH-Config IE.

It should be noted that the “beam” in this disclosure may be equivalent to a spatial (domain) filtering. In some examples, the spatial filtering may be applied in an analog domain by adjusting the phase and/or amplitude of the signal before transmitted by a corresponding antenna element. In some examples, the spatial filtering may be applied in a digital domain by a Multi-input Multi-output (MIMO) technique in a wireless communication system. For example, a UE performing a PUSCH transmission by using a specific beam may indicate that the UE performs the PUSCH transmission by using the specific spatial/digital domain filter. The “beam” may also include, but is not limited to, an antenna, an antenna port, an antenna element, a group of antennas, a group of antenna ports, or a group of antenna elements. The beam may also be formed by a certain reference signal resource. In brief, the beam may be equivalent to a spatial domain filter which radiates the EM wave through.

It should be noted that “transmitted” in all the implementations and embodiments disclosed herein may be defined as a corresponding MAC CE/MAC PDU/layer 1 signaling/higher layer signaling is started to be transmitted, completely transmitted, or already delivered to a corresponding HARQ process/buffer for transmission. The “transmitted” in all the implementations and embodiments disclosed herein may also be defined as the HARQ_ACK feedback (e.g., a response from the gNB) of the MAC PDU carrying the MAC CE/MAC PDU/layer 1 signaling/higher layer signaling is received. The “transmitted” in all the implementations and embodiments disclosed herein may also be defined as a corresponding MAC CE/MAC PDU is built.

It should be noted that the “HARQ_ACK feedback” may be implemented as a DCI format 0_0, 0_1 or some other formats of DCI that may be received by the UE from the gNB on a PDCCH. The received DCI may contain a new data indicator (NDI) which is set to a specific value (e.g., 1) and the DCI may also indicate a HARQ process ID which is the same as a HARQ process ID applied by, or indicated to be used for, the HARQ process of the MAC PDU (e.g., carrying the BFRQ MAC CE) transmission.

The PDCCH in this disclosure may be transmitted by the gNB to the UE. In other words, the PDCCH may be received by the UE from the gNB. The PDSCH in this disclosure may be transmitted by the gNB to the UE. In other words, the PDSCH may be received by the UE from the gNB. The PUSCH in this disclosure may be transmitted by the UE to the gNB. In other words, the PUCCH may be received by the gNB from the UE.

A PDSCH/PDSCH/PUSCH transmission may be spanning multiple of symbols in the time domain. A time duration of a PDSCH/PDSCH/PUSCH (e.g., transmission) may imply a time interval that starts from the beginning of the first symbol of the PDSCH/PDSCH/PUSCH and that ends at the end of the last symbol of the PDSCH/PDSCH/PUSCH.

The term “A and/or B” within the present disclosure means “A”, “B” or “A and B”. The term “A and/or B and/or C” within the present disclosure means “A”, “B”, “C”, “A and B”, “A and C”, “B and C” or “A and B and C”.

The term “A/B” within the present disclosure means “A” or “B”.

The term “interrupt” within the present disclosure may have the same meaning as “stop”, “cancel” or “skip” in the present disclosure.

The phrase “instruct the PHY to generate acknowledgement” may have the same meaning as “instruct the PHY to perform HARQ-ACK feedback” in the present disclosure.

The term “acknowledgement” may have the same meaning as “HARQ-ACK” or “HARQ-ACK feedback” in the present disclosure.

It should be noted that the phrase “the UE may not need to perform the corresponding HARQ feedback” in the present disclosure may be the same as “the HARQ entity/HARQ process may not need to perform the corresponding HARQ feedback”.

In the present disclosure, the phrase “by specific Physical layer signaling” may include, but is not limited to:
By a specific format of DCI;
By a specific field of a DCI;
By a specific field of a DCI, and the field is set to a specific value; or
By a DCI with CRC bits scrambled with a specific RNTI.

In the present disclosure, “a MAC timer” may be configured by an RRC message which is indicated by the gNB. The UE may be configured with an initial value of the timer and the unit of the value may include, but is not limited to, a frame/sub-frame/milli second/sub-milli second/slot/symbol. The timer may be started and/or restarted by the UE (e.g., UE's MAC entity). The timer may be started and/or restarted by the UE (e.g., UE's MAC entity) when some specific condition is satisfied.

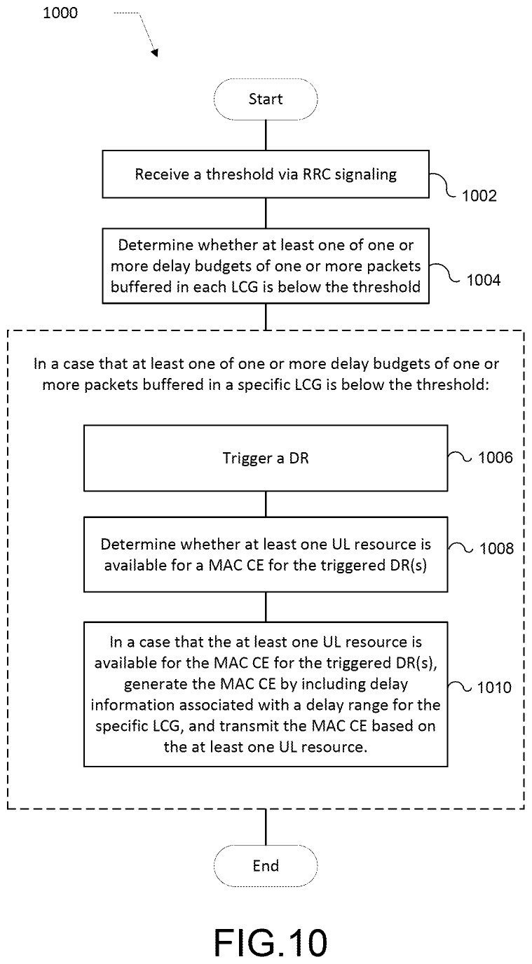

FIG. 10 is a flowchart for a method/process 1000 for delay information reporting, according to an example implementation of the present disclosure. In some embodiment the process 1000 may be performed by a UE. It should be noted that although actions 1002, 1004, 1006, 1008, and 1010 are illustrated as separate actions represented as independent blocks in FIG. 10, these separately illustrated actions should not be construed as necessarily order-dependent. The order in which the actions are performed in FIG. 10 is not intended to be construed as a limitation, and any number of the disclosed blocks may be combined in any order to implement the method, or an alternate method. Moreover, each of actions 1002, 1004, 1006, 1008, and 1010 may be performed independently of other actions and may be omitted in some implementations of the present disclosure.

In action 1002, the process 1000 may start by receiving a first threshold via RRC signaling. For example, a UE may receive the first threshold from a base station via RRC signaling, and the first threshold may be a PDB threshold.

In some implementations, the UE may receive a second threshold from the base station.

For example, the first threshold may be associated with a first LCG, and the second threshold may be associated with a second LCG. In other words, the threshold may be configured per LCG.

In action 1004, the process 1000 may determine whether at least one of one or more delay budgets of one or more packets buffered in each LCG is below the (corresponding) threshold. Specifically, for each of the LCG(s), the UE may determine whether there is any packet buffered in the LCG that has a delay budget below the (corresponding) threshold.

In a case that (the UE determines that) at least one of the one or more delay budgets of the one or more packets buffered in specific LCG(s) is below the (corresponding) threshold, the process 1000 may proceed to action 1006 to trigger a delay information reporting. Specifically, in a case that there is at least one packet buffered in an LCG having a delay budget below the (corresponding) threshold, a DR may be triggered for each specific LCG.

It should be noted that the term “specific LCG” may indicate an LCG that buffers at least a packet having a delay budget below the corresponding threshold.

In some implementations, the specific LCG(s) may include a first LCG. That is, the first LCG may buffer at least a packet having a delay budget below the first threshold corresponding to the first LCG. In this case, a first DR may be triggered.

In some implementations, the specific LCG(s) may also include a second LCG (e.g., in addition to the first LCG). That is, in addition to the first LCG, a second LCG may also buffer at least a packet having a delay budget below the second threshold corresponding to the second LCG. In this case, a second DR may be triggered.

In other words, the UE may determine that there are more than one LCG, each of which buffering at least a packet having a delay budget below the (corresponding) threshold. Also, the UE may trigger more than one DRs.

It should be noted that, definitions of the term “trigger” here may be the same as that in the 3GPP technical specification, which one of ordinary skilled in the art should have realized. For example, once a DR is triggered, the UE may start to prepare the information related to the DR (e.g., perform calculations needed by the DR), while the MAC CE for the DR (e.g., the DR MAC CE) has not been generated. The prepared information may be used for generating the MAC CE for the DR.

In action 1008, the process 1000 may determine whether at least one UL resource is available for the MAC CE for the triggered DR(s). Specifically, the UE may determine whether there is a UL resource available for the transmission of the DR MAC CE.

In some implementations, the triggered DR(s) may include the first DR.

In some implementations, the triggered DR(s) may include the first DR and the second DR.

In a case that (the UE determines that) at least one UL resource is available for the MAC CE for the triggered DR(s), the process 1000 may proceed to action 1010.

In action 1010, in a case that at least one UL resource is available for the MAC CE for the triggered DR(s), the process 1000 may generate the MAC CE by including the delay information associated with a delay range for the specific LCG(s) and may transmit the MAC CE based on the available at least one UL resource. The process 1000 may then end.

For example, in a case that the specific LCG(s) includes the first LCG, the MAC CE may include the delay information associated with a first delay range for the first LCG.

For example, in a case that the specific LCG(s) further includes the second LCG, the MAC CE may further include the delay information associated with a second delay range for the second LCG.

In some implementations, the delay information may indicate a smallest delay budget within each LCG. For example, the delay information may indicate a smallest delay budget within the first LCG. For example, the delay information may further indicate a smallest delay budget within the second LCG.

In some implementations, the MAC CE may include information of the number of LCGs corresponding to the delay information. Specifically, the MAC CE may include information of how many LCGs that buffer at least a packet that has a delay budget below the threshold.

For example, in a case that the specific LCG(s) only includes the first LCG, there is only one LCG corresponding to the delay information. For example, in a case that the specific LCG(s) includes the first LCG and the second LCG, there may be two LCGs corresponding to the delay information.

In some implementations, the MAC CE may include buffer information indicating an amount of data for transmission in each specific LCG. Specifically, for generating the MAC CE, the UE may determine the buffer information that indicates an amount of data for transmission in each specific LCG based on the amount of data and a first mapping table, then include the buffer information in the MAC CE.

For example, in a case that the specific LCG(s) includes the first LCG, the buffer information may indicate, based on a relationship stored in a first mapping table, the amount of data for transmission in the first LCG. For example, in a case that the specific LCG(s) further includes the second LCG, the buffer information may further indicate, based on a relationship stored in the second mapping table, the amount of data for transmission in the second LCG. The first mapping table and the second mapping table may be, for example, the same mapping table.

In some implementations, the first mapping table may be selected from two or more pre-defined mapping tables. Specifically, a UE may be configured/implemented with more than one pre-defined mapping table, and the UE may select one of the configured/implemented pre-defined mapping tables as the first mapping table (or the second mapping table) for determining the buffer information.

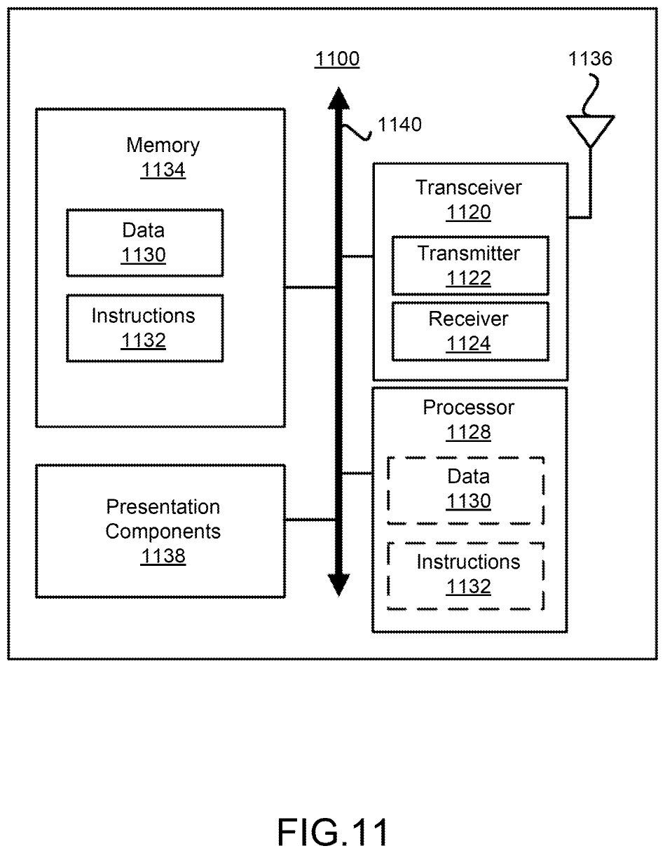

FIG. 11 is a block diagram illustrating a node 1100 for wireless communication, according to an example implementation of the present disclosure. As illustrated in FIG. 11, a node 1100 may include a transceiver 1120, a processor 1128, a memory 1134, one or more presentation components 1138, and at least one antenna 1136. The node 1100 may also include a radio frequency (RF) spectrum band module, a BS communications module, a NW communications module, and a system communications management module, Input/Output (I/O) ports, I/O components, and a power supply (not illustrated in FIG. 11).

Each of the components may directly or indirectly communicate with each other over one or more buses 1140. The node 1100 may be a UE or a BS that performs various functions disclosed with reference to FIGS. 1 to 10.

The transceiver 1120 has a transmitter 1122 (e.g., transmitting/transmission circuitry) and a receiver 1124 (e.g., receiving/reception circuitry) and may be configured to transmit and/or receive time and/or frequency resource partitioning information. The transceiver 1120 may be configured to transmit in different types of subframes and slots including, but not limited to, usable, non-usable and flexibly usable subframes and slot formats. The transceiver 1120 may be configured to receive data and control channels.

The node 1100 may include a variety of computer-readable media. Computer-readable media may be any available media that may be accessed by the node 1100 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information, such as computer-readable instructions, data structures, program modules or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired NW or direct-wired connection, and wireless media, such as acoustic, RF, infrared, and other wireless media. Combinations of any of the previously listed components should also be included within the scope of computer-readable media.

The memory 1134 may include computer-storage media in the form of volatile and/or non-volatile memory. The memory 1134 may be removable, non-removable, or a combination thereof. Example memory may include solid-state memory, hard drives, optical-disc drives, etc. As illustrated in FIG. 11, the memory 1134 may store a computer-readable and/or computer-executable instructions 1132 (e.g., software codes or programs) that are configured to, when executed, cause the processor 1128 to perform various functions disclosed herein, for example, with reference to FIGS. 1 to 10. Alternatively, the instructions 1132 may not be directly executable by the processor 1128 but may be configured to cause the node 1100 (e.g., when compiled and executed) to perform various functions disclosed herein.

The processor 1128 (e.g., having processing circuitry) may include an intelligent hardware device, e.g., a Central Processing Unit (CPU), a microcontroller, an ASIC, etc. The processor 1128 may include memory. The processor 1128 may process the data 1130 and the instructions 1132 received from the memory 1134, and information transmitted and received via the transceiver 1120, the baseband communications module, and/or the NW communications module. The processor 1128 may also process information to send to the transceiver 1120 for transmission via the antenna 1136 to the NW communications module for transmission to a Core Network (CN).

One or more presentation components 1138 may present data indications to a person or another device. Examples of presentation components 1138 may include a display device, a speaker, a printing component, a vibrating component, etc.

In view of the present disclosure, various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are considered in all respects as illustrative and not restrictive. It should also be understood that the present disclosure is not limited to the specific implementations disclosed. Still, many rearrangements, modifications, and substitutions are possible without departing from the scope of the present disclosure.

What is claimed is:

1. A method performed by a user equipment (UE), the method comprising:
receiving a first threshold via radio resource control (RRC) signaling;
determining whether at least one of one or more delay budgets of one or more packets buffered in a first logical channel group (LCG) is below the first threshold; and
in a case that the at least one of the one or more delay budgets of the one or more packets buffered in the first LCG is below the first threshold:
triggering a first delay information reporting (DR),
determining whether at least one uplink resource is available for a medium access control (MAC) control element (CE) for the first DR, and
in a case that the at least one UL resource is available for the MAC CE for the first DR, generating the MAC CE by including delay information associated with a first delay range for the first LCG, and transmitting the MAC CE based on the at least one UL resource.

2. The method of claim 1, wherein the delay information associated with the first delay range for the first LCG indicates a smallest delay budget within the first LCG.

3. The method of claim 1, wherein the MAC CE includes information associated with a number of LCGs corresponding to the delay information.

4. The method of claim 1, further comprising:
determining buffer information indicating an amount of data for transmission in the first LCG based on the amount of data and a first mapping table; and
including the buffer information in the MAC CE.

5. The method of claim 4, further comprising:
selecting the first mapping table from a plurality of pre-defined mapping tables.

6. The method of claim 1, further comprising:
receiving a second threshold via the RRC signaling;
determining whether at least one of one or more delay budgets of one or more packets buffered in a second LCG is below the second threshold; and
in a case that the at least one of the one or more delay budgets of the one or more packets buffered in the second LCG is below the second threshold:
triggering a second DR, wherein:
determining whether the at least one uplink resource is available for the MAC CE for the first DR comprises determining whether the at least one uplink resource is available for the MAC CE for the first DR and the second DR, and
in a case that the at least one UL resource is available for the MAC CE for the first DR and the second DR, the MAC CE is generated by further including the delay information associated with a second delay range for the second LCG.

7. The method of claim 6, wherein the delay information associated with the second delay range for the second LCG indicates a smallest delay budget within the second LCG.

8. A user equipment (UE), comprising:
at least one processor; and
at least one non-transitory computer-readable medium coupled to the at least one processor and storing one or more computer-executable instructions that, when executed by the at least one processor, cause the UE to:
receive a first threshold via radio resource control (RRC) signaling;
determine whether at least one of one or more delay budgets of one or more packets buffered in a first logical channel group (LCG) is below the first threshold; and
in a case that the at least one of the one or more delay budgets of the one or more packets buffered in the first LCG is below the first threshold:
trigger a first delay information reporting (DR),
determine whether at least one uplink resource is available for a medium access control (MAC) control element (CE) for the first DR, and
in a case that the at least one UL resource is available for the MAC CE for the first DR, generate the MAC CE by including delay information associated with a first delay range for the first LCG, and transmit the MAC CE based on the at least one UL resource.

9. The UE of claim 8, wherein the delay information associated with the first delay range for the first LCG indicates a smallest delay budget within the first LCG.

10. The UE of claim 8, wherein the MAC CE includes information associated with a number of LCGs corresponding to the delay information.

11. The UE of claim 8, wherein the one or more computer-executable instructions, when executed by the at least one processor, further cause the UE to:
determine buffer information indicating an amount of data for transmission in the first LCG based on the amount of data and a first mapping table; and
include the buffer information in the MAC CE.

12. The UE of claim 11, wherein the one or more computer-executable instructions, when executed by the at least one processor, further cause the UE to:
select the first mapping table from a plurality of pre-defined mapping tables.

13. The UE of claim 8, wherein the one or more computer-executable instructions, when executed by the at least one processor, further cause the UE to:
receive a second threshold via the RRC signaling;
determine whether at least one of one or more delay budgets of one or more packets buffered in a second LCG is below the second threshold;
in a case that the at least one of the one or more delay budgets of the one or more packets buffered in the second LCG is below the second threshold:
trigger a second DR, wherein:
determining whether the at least one uplink resource is available for the MAC CE for the first DR comprises determining whether the at least one uplink resource is available for the MAC CE for the first DR and the second DR, and
in a case that the at least one UL resource is available for the MAC CE for the first DR and the second DR, the MAC CE is generated by further including the delay information associated with a second delay range for the second LCG.

14. The UE of claim 13, wherein the delay information associated with the second delay range for the second LCG indicates a smallest delay budget within the second LCG.
